(19) United States
(12) Patent Application Publication
(10) Pub. No.: US 2026/0217298 A1
(43) Pub. Date: Jul. 30, 2026

(54) BRAKING MECHANISM AND CHILD STROLLER COMPRISING THE SAME

(71) Applicant: Wonderland Switzerland AG, Steinhausen (CH)

(72) Inventors: Xiaolong YI, Dongguan, Guangdong (CN); Shoufeng HU, Dongguan, Guangdong (CN)

(21) Appl. No.: 19/146,488

(22) PCT Filed: Jan. 19, 2024
(86) PCT No.: PCT/EP2024/051222

§ 371 Date: Jul. 8, 2025

(30) Foreign Application Priority Data
Jan. 19, 2023 (CN) 2023100776331
Jan. 12, 2024 (CN) 2024100551559

(51) Int. Cl. B62B 9/08

(52) U.S. Cl. CPC B62B 9/087; B62B 9/082

(57) ABSTRACT

A braking mechanism and a child stroller comprising the same. The braking mechanism includes: a first locking mechanism for locking a first wheel; wherein the first locking mechanism includes an operating member and a first elastic member, and locking and unlocking of the first wheel is realized by cooperation between the operating member and the first elastic member, the first elastic member provides a pressing force in a locking direction when the operating member of the first locking mechanism performs a locking operation, and provides a releasing force in an unlocking direction when the operating member of the first locking mechanism performs an unlocking operation.

This application is a National Stage application of PCT/EP2024/051222, entitled “barking mechanism and child stroller comprising the same” and filed on Jan. 19, 2024, which claims the benefit of CN. application No. 2023100776331 filed on Jan. 19, 2023, and CN. application No. 2024100551559 filed on Jan. 12, 2024, all of which are incorporated herein by reference in their entirety.

### TECHNICAL FIELD

The present application relates to a braking mechanism and a child stroller including the same.

### BACKGROUND

Child strollers can alleviate the fatigue caused by holding babies for a long time, and improve comfortability of people's life. In order to avoid safety accidents caused by sliding inadvertently of the child stroller, a braking mechanism is usually disposed on a rear wheel of the child stroller, and the rear wheel may be locked with the braking mechanism so as to brake the whole child stroller.

However, the existing braking mechanism needs to be provided with a corresponding linkage structure to simultaneously brake the left rear wheel and the right rear wheel, so that the structure is complicated, the brake failure phenomenon is easily formed, and the stability is poor.

### SUMMARY

The present application provides a braking mechanism with simple structure and strong stability, and a child stroller including the same.

According to one solution of the present application, there is provided a braking mechanism including: a first locking mechanism for locking a first wheel; wherein the first locking mechanism includes an operating member and a first elastic member, and the first wheel is locked and unlocked by cooperation between the operating member and the first elastic member, the first elastic member provides a pressing force in a locking direction when the operating member of the first locking mechanism performs a locking operation, and provides a releasing force in an unlocking direction when the operating member of the first locking mechanism performs an unlocking operation.

According to some embodiments, the pressing force is applied to the operating member in a direction different from a direction in which the releasing force is applied to the operating member.

According to some embodiments, the operating member includes a pivoting portion and an actuating portion which are respectively at two ends of the operating member; the first locking mechanism includes a first support frame, the first support frame is provided with a pivoting shaft, and the pivoting portion of the operating member is connected to the pivoting shaft, so that the operating member is rotatable about the pivoting shaft.

According to some embodiments, the first support frame includes a first cover body and a second cover body, and the first cover body and the second cover body are snap-fitted with each other to form a space for accommodating the pivoting portion of the operating member.

According to some embodiments, the first locking structure further includes a first locking groove which is disposed on a hub frame of the first wheel.

According to some embodiments, the operating member further includes: a first snapping end, one end of the towing member connected with the first locking mechanism surrounds the pivoting portion of the operating member and is connected to the first snapping end; and a first engaging end which is lockable to the first locking groove or is unlockable from the first locking groove.

According to some embodiments, the first elastic member of the first locking structure is disposed on the side of the first cover body facing the first wheel.

According to some embodiments, the first elastic member includes a first end and a second end which are opposite, the first end is connected to a first fixed portion disposed on the first cover body, and the second end is connected to a second fixed portion disposed on the operating member.

According to some embodiments, a connecting line connecting the second fixed portion of the operating member and the first fixed portion of the first cover body in a locked state forms an angle with a connecting line connecting the second fixed portion of the operating member and the first fixed portion of the first cover body in an unlocked state, and the angle is in the range of 35°-50°, for example.

According to some embodiments, in the locked state, the first elastic member is located below the pivoting point of the operating member, and in the unlocked state, the first elastic member is located above the pivoting point of the operating member.

According to some embodiments, in the locked state, the elastic force of the first elastic member is divided into a first component force perpendicular to the operating member and a second component force along the operating member to ensure that the operating member is depressed.

According to some embodiments, in the unlocked state, the elastic force of the first elastic member is divided into a first component force perpendicular to the operating member and a second component force along the operating member to ensure that the operating member is lifted.

According to some embodiments, the first cover body is further provided with a stop portion which is used for blocking the operating member from continuously pivoting upwards in the unlocked state.

According to some embodiments, the braking mechanism further includes a second locking mechanism and the second locking mechanism includes: a second support frame; an engaging member accommodated in the second support frame; and a second elastic member connected to the engaging member, and the elastic force of the second elastic member causes the second locking mechanism to be in the locked state.

According to some embodiments, the second support frame includes a third cover body and a fourth cover body, and the third cover body and the fourth cover body are snap-fitted with each other to form an accommodating space for accommodating the engaging member.

According to some embodiments, the fourth cover body is provided with a limiting groove, and the engaging member is movably disposed in the limiting groove.

According to some embodiments, the second locking mechanism further includes a second locking groove which is disposed on the hub frame of the second wheel.

According to some embodiments, the engaging member includes a second snapping end disposed at one end and a second engaging end disposed at the other end, the second snapping end connects the second elastic member, and the one end of the towing member connected with the second locking mechanism is connected to the second snapping end, and the second engaging end is lockable to the locking groove or unlockable from the locking groove.

According to some embodiments, the braking mechanism further includes towing member, and both locking and unlocking of the first locking mechanism and the second locking mechanism are linked through the towing member.

The present application also provides a braking mechanism including: a first locking mechanism including a braking operating member and a first elastic member for simultaneously locking a first wheel and a second wheel; a second locking mechanism including an unlocking operating member and a second elastic member for simultaneously unlocking the first wheel and the second wheel, the first elastic member having an elastic force larger than that of the second elastic member; and a towing member, the first locking mechanism and the second locking mechanism are linked through the towing member.

According to some embodiments, the first locking mechanism includes a first support frame, and the first support frame includes a first cover body and a second cover body, and the first cover body and the second cover body are snap-fitted with each other to form an accommodating space for accommodating the braking operating member.

According to some embodiments, the second cover body is provided with a first pivoting shaft, and the braking operating member includes a first pivoting portion and a first actuating portion, the first pivoting portion is pivoted on the first pivoting shaft, and the first elastic member is disposed between the first pivoting portion and the first cover body.

According to some embodiments, the braking operating member further includes a first snapping end disposed on the first pivoting portion, and one end of the towing member connected with the first locking mechanism is connected to the first snapping end.

According to some embodiments, the first locking mechanism further includes a first engaging groove which is disposed on a hub frame of the first wheel; the braking operating member further includes a first engaging end disposed on the first pivoting portion, and the first engaging end is lockable to the first engaging groove or unlockable from the first engaging groove.

According to some embodiments, the braking operating member further includes a first protrusion disposed on the first pivoting portion, and the second cover body further includes a second protrusion, and the locked and unlocked states of the braking operating member are maintained respectively through different fitting ways of the first protrusion and the second protrusion.

According to some embodiments, the first protrusion includes two protrusions radially oppositely disposed around the first pivoting portion, and the second protrusion includes two protrusions radially oppositely disposed around the first pivoting shaft.

According to some embodiments, the second locking mechanism includes a second support frame, and the second support frame includes a third cover body and a fourth cover body, and the third cover body and the fourth cover body are snap-fitted with each other to form an accommodating space for accommodating the unlocking operating member.

According to some embodiments, the fourth cover body is provided with a second pivoting shaft, and the unlocking operating member includes a second pivoting portion and a second actuating portion, the second pivoting portion is pivoted on the second pivoting shaft, and the second elastic member is disposed between the second pivoting portion and the fourth cover body.

According to some embodiments, the unlocking operating member further includes a second snapping end disposed on the second pivoting portion, and the one end of the towing member connected with the second locking mechanism is connected to the second snapping end.

According to some embodiments, the second locking mechanism further includes a second engaging groove which is disposed on a hub frame of the second wheel; the unlocking operating member further includes a second engaging end disposed on the second pivoting portion, and the second engaging end is lockable to the second engaging groove or unlockable from the second engaging groove.

The towing member of the present application can be a separated structure and includes a first towing portion and a second towing portion which are connected to each other through a connecting member.

According to some embodiments, the connecting member includes a first opening and a second opening for receiving a first end part of the first towing portion and a second end part of the second towing portion, respectively; and a first fitting slot and a second fitting slot, the first fitting slot has a dimension smaller than that of the first opening, the second fitting slot has a dimension smaller than that of the second opening, and the first fitting slot is communicated with the first opening, the second fitting slot is communicated with the second opening.

According to some embodiments, the connecting member is provided at the connecting crossbar which connects the left wheel and the right wheel.

According to some embodiments, the connecting crossbar is provided with a first perforation and a second perforation, the first end part of the first towing portion penetrates from the first perforation, the second end part of the second towing portion penetrates from the second perforation; and a receiving portion, the connecting member is received in the receiving portion and covered by a cover body.

The present application also provides a child stroller including: a wheel assembly including a left wheel and a right wheel; a frame which is supported on the wheel assembly; and a braking mechanism as described above.

### BRIEF DESCRIPTION OF THE DRAWINGS

The accompanying drawings are included herein to provide a further understanding of the disclosure, and are incorporated into this specification to constitute a part of this specification. The accompanying drawings show embodiments of the disclosure, and are used together with the following description to illustrate the principle of the disclosure.

In the accompanying drawings:

FIG. 1 is a schematic view showing a child stroller according to a first embodiment of the present application;

FIG. 2 is a schematic view showing a braking mechanism according to the first embodiment of the present application;

FIG. 3 is a schematic view showing the first locking mechanism according to the first embodiment of the present application, with the braking operating member in a locked state;

FIG. 4 is a schematic view showing the first locking mechanism according to the first embodiment of the present application, with the braking operating member in an unlocked state;

FIG. 5 is an exploded schematic view showing the first locking mechanism according to the first embodiment of the present application;

FIG. 6 is a schematic view showing another view of the first locking mechanism according to the first embodiment of the present application;

FIG. 7 is another schematic diagram showing another view of the first locking mechanism according to the first embodiment of the present application;

FIGS. 8 and 9 show the corresponding positions of the first elastic member in the locked and unlocked states, respectively, of the braking operating member according to the first embodiment of the present application;

FIG. 10 shows the corresponding angle of the first elastic member when the braking operating member according to the first embodiment of the present application is in the locked state and the unlocked state, respectively;

FIG. 11 is a schematic view showing the second locking mechanism according to the first embodiment of the present application, with the second locking mechanism in a locked state;

FIG. 12 is a schematic view showing the second locking mechanism according to the first embodiment of the present application, with the second locking mechanism in an unlocked state;

FIG. 13 is an exploded schematic view showing the second locking mechanism according to the first embodiment of the present application;

FIG. 14 is a schematic view showing the braking mechanism according to the second embodiment of the present application, in which both left and right wheels are in an unlocked state;

FIG. 15 is a schematic view showing the braking mechanism according to the second embodiment of the present application, in which both the left and right wheels are in a locked state;

FIG. 16 is a schematic view showing the first locking mechanism according to the second embodiment of the present application;

FIG. 17 is another schematic view showing the first locking mechanism according to the second embodiment of the present application;

FIG. 18 is an exploded schematic view showing another view of the first locking mechanism according to the second embodiment of the present application;

FIG. 19 is a schematic view showing the second locking mechanism according to the second embodiment of the present application;

FIG. 20 is another schematic view showing the second locking mechanism according to the second embodiment of the present application;

FIG. 21 is a schematic view showing an another embodiment of the towing member, in which the cover body is covered on the connecting crossbar;

FIG. 22 is a schematic view showing an another embodiment of the towing member, in which the cover body is removed from the connecting crossbar to clearly show the inner structure; and

FIG. 23 is a partial schematic diagram showing the connecting portion of the towing member.

List of reference numerals:

```
  1 child stroller
      50 frame
          52 connecting crossbar
            521 first perforation 522 second perforation 523 receiving portion
      60 wheel assembly
          62 right wheel 621 hub frame of right wheel
          64 left wheel 641 hub frame of left wheel
first embodiment
10 braking mechanism
    100 first locking mechanism
        110 operating member
            112 second fixed portion 113 pivoting portion 114 actuating portion
            115 first snapping end 116 first engaging end
        120 first cover body
            121 stop portion 122 first fixed portion
        130 second cover body
            132 pivoting shaft
        150 first elastic member
            152 first end 154 second end
        160 first locking groove
    200 second locking mechanism
        220 third cover body
        230 fourth cover body
            231 limiting groove
        250 second elastic member
        270 engaging member
            271 second snapping end 272 second engaging end
        260 second locking groove
    300 towing member
        310 first towing portion
            312 first end part
        320 second towing portion
            322 second end part
    400 connecting member
        410 first opening 420 second opening
        430 first fitting slot 440 second fitting slot
    500 cover body
        510 connecting hole
    A pivoting point
    F elastic force of first elastic member
        F′ first component force
        F″ second component force
    L1 connecting line
    L2 connecting line
    α angle between connecting line L1 and connecting line L2
    X pivoting axis
second embodiment
      10′ braking mechanism
        100′ first locking mechanism
        110′ braking operating member
            115′ first snapping end 113′ first pivoting portion
            114′ first actuating portion 116′ first engaging end 117′ first protrusion
        120′ first cover body
        130′ second cover body
            132′ first pivoting shaft 134′ second protrusion
        150′ first elastic member
        160′ first engaging groove
    200′ second locking mechanism
        210′ unlocking operating member
            215′ second snapping end 216′ second engaging end
            213′ second pivoting portion 214′ second actuating portion
        220′ third cover body
        230′ fourth cover body
            232′ second pivoting shaft
        250′ second elastic member
        260′ second engaging groove
    300′ towing member
```

### DETAILED DESCRIPTION

Hereinafter, exemplary embodiments will be described in detail with reference to the accompanying drawings. Although the disclosure is susceptible to various modifications and alternatives, specific embodiments thereof are shown by way of example in the accompanying drawings. However, the disclosure should not be construed as being limited to the embodiments set forth herein, but on the contrary, the disclosure will cover all modifications, equivalents, and alternatives that fall within the spirit and scope of the embodiments.

In the following description, a child stroller is taken as an example, but the braking mechanism according to the present application is not limited to the child stroller, and may be other child equipment that requires braking.

### A First Embodiment

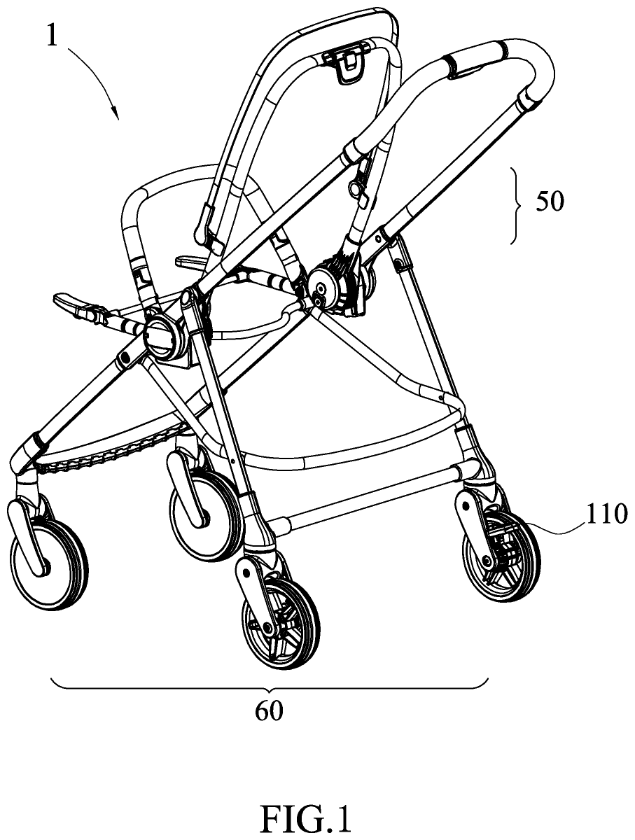

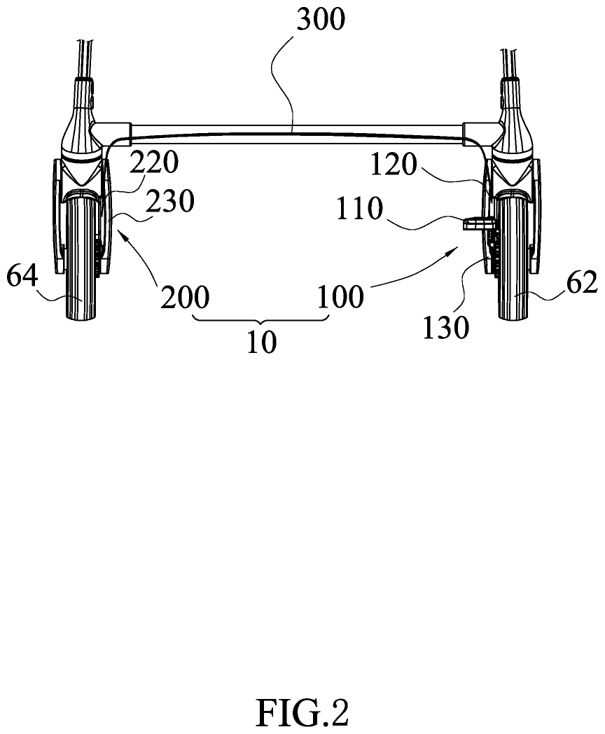

Referring to FIG. 1, FIG. 1 is a schematic view showing a child stroller according to a first embodiment of the present application, and the child stroller 1 generally includes a wheel assembly 60 and a frame 50 supported on the wheel assembly 60. And referring to FIG. 2, FIG. 2 is a schematic view showing a braking mechanism according to the first embodiment of the present application, the wheel assembly 60 generally including a first wheel 62 and a second wheel 64, the first wheel 62 is a right wheel 62 and the second wheel 64 is a left wheel 64 according to this specific embodiment, but not limited thereto. In order to avoid safety accidents caused by sliding inadvertently of the child stroller, an operating member 110 is disposed on the right wheel 62. A supervisor may operate the operating member 110 to make the right wheel 62 and the left wheel 64 in locked state simultaneously when the child stroller 1 is parked temporarily, so as to avoid sliding inadvertently of the child stroller 1. According to this embodiment, the wheel assembly 60 may be, for example, a rear wheel assembly, and accordingly, the left wheel 64 is a left rear wheel and the right wheel 62 is a right rear wheel; the operating member 110 may be a pedal, but is not limited to the above. The child stroller 1 according to the present application further includes a braking mechanism 10. As shown in FIG. 2, the braking mechanism 10 generally includes a first locking mechanism 100, a second locking mechanism 200, a towing member 300, and the towing member of which may be in the form of a pulling rope, for example, but not limited thereto. Based on the embodiment shown in FIG. 2, the first locking mechanism 100 is used for locking the right wheel 62, and the second locking mechanism 200 is used for locking the left wheel 64, but not limited thereto. The towing member 300 of the braking mechanism 10 is used for linking the first locking mechanism 100 and the second locking mechanism 200, so that the left wheel 64 and the right wheel 62 may be simultaneously locked by, for example, depressing the operating member 110, and the left wheel 64 and the right wheel 62 can be simultaneously unlocked by, for example, lifting up the operating member 110.

FIG. 2 also shows a first support frame of the first locking mechanism 100. According to this embodiment, the first support frame includes a first cover body 120 and a second cover body 130. FIG. 2 also shows the second locking mechanism 200 including a second support frame, which includes, for example, a third cover body 220 and a fourth cover body 230, the first cover body 120 and the second cover body 130 are snap-fitted with each other to form an accommodating space. Likewise, the third cover body 220 and the fourth cover body 230 are snap-fitted with each other to form another accommodating space.

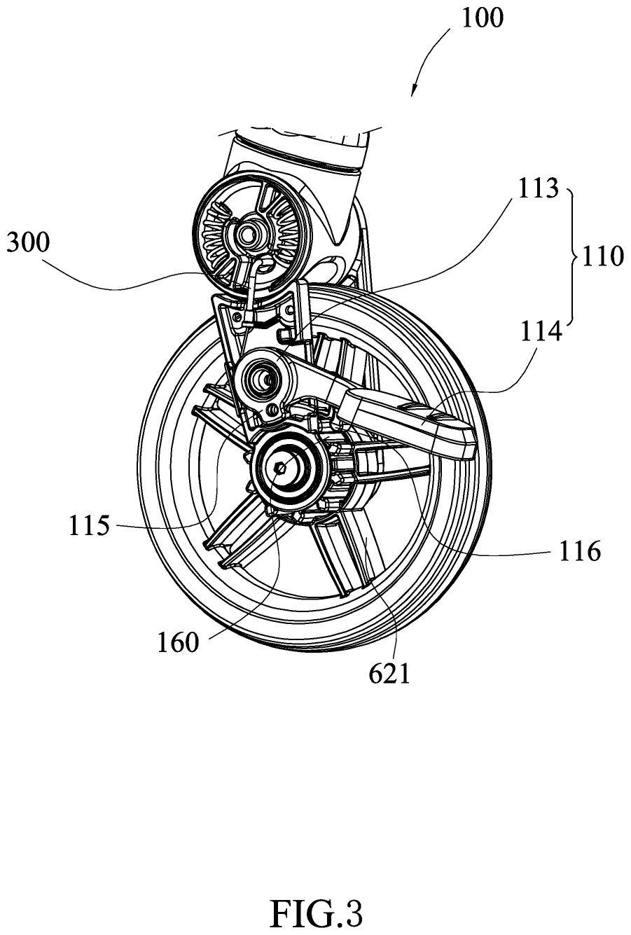

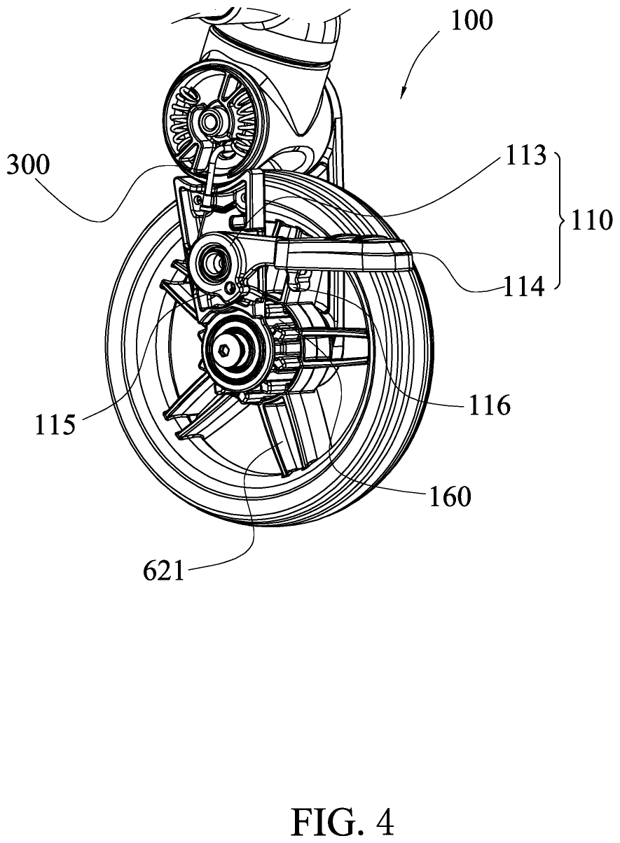

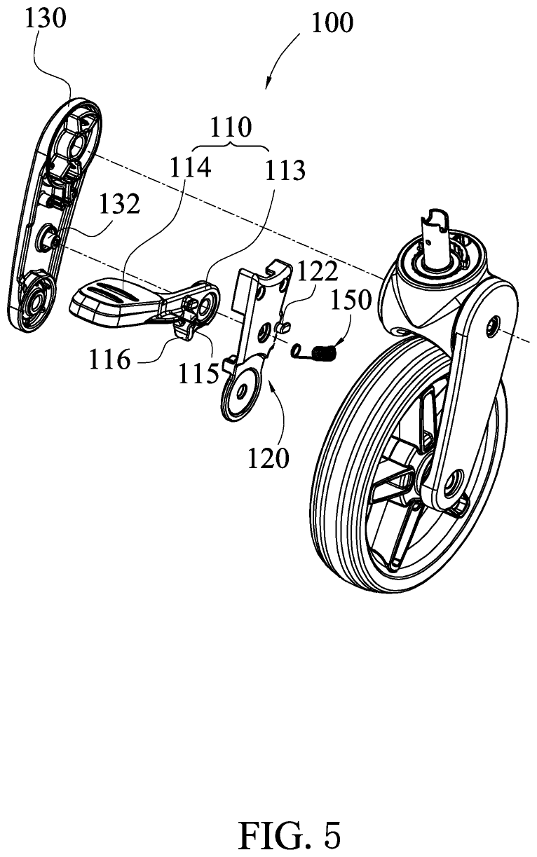

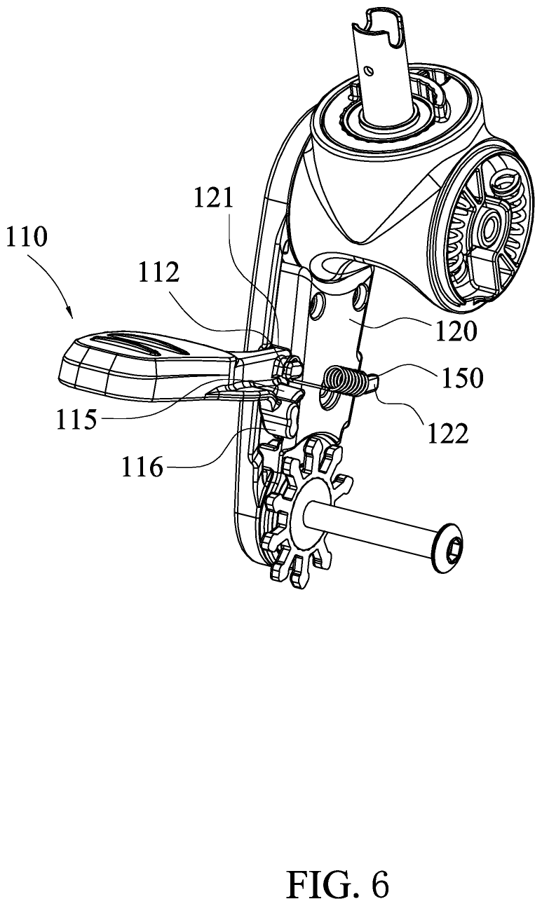

The structure of the first locking mechanism 100 is specifically described below with reference to FIG. 3, FIG. 4, FIG. 5, and FIG. 6, wherein FIG. 3 is a schematic view showing the first locking mechanism according to the first embodiment of the present application, with the operating member in FIG. 3 in a locked state; FIG. 4 is a schematic view showing the first locking mechanism according to the first embodiment of the present application, with the operating member in FIG. 4 in an unlocked state; FIG. 5 is an exploded schematic view showing the first locking mechanism according to the first embodiment of the present application; FIG. 6 is a schematic view showing another view of the first locking mechanism according to the first embodiment of the present application. The first locking mechanism 100 mainly includes an operating member 110 and a first elastic member 150 (shown in FIGS. 5 and 6). Specifically, the operating member 110 further includes a pivoting portion 113 and an actuating portion 114 respectively disposed at two ends thereof. The pivoting portion 113 of the operating member 110 is disposed in the accommodating space formed by the first cover body 120 and the second cover body 130, and the actuating portion 114 of the operating member 110 is exposed from the accommodating space formed by the first cover body and the second cover body 130 (with reference to FIG. 2), so as to facilitate the supervisor to perform a stepping operation, for example. The operating member 110 further includes a first snapping end 115 and a first engaging end 116. The first snapping end 115 is connected with one end of the towing member 300 (i.e., the end of the towing member 300 connected with the first locking mechanism 100), and the first engaging end 116 is lockable in the first locking groove 160 provided on the hub frame 621 of the right wheel 62 or can be disengaged from the first locking groove 160 to unlock.

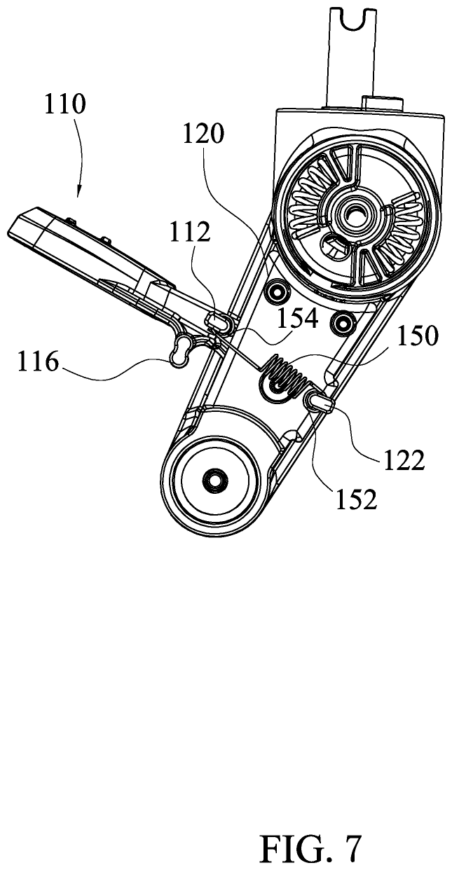

Further, as shown in FIG. 5, the second cover body 130 of the first locking mechanism 100 is provided with a pivoting shaft 132, and the pivoting portion 113 of the operating member 110 is connected to the pivoting shaft 132 such that the operating member 110 can rotate about the pivoting shaft 132. The first elastic member 150 of the first locking mechanism 100 is disposed on the side of the first cover body 120 facing the right wheel 62. The simultaneous locking and unlocking of the right and left wheels 62 and 64 can be achieved by the cooperation between the operating member 110 and the first elastic member 150 and the linkage effect of the above towing member 300. Referring to FIG. 7 again, FIG. 7 is another schematic diagram showing another view of the first locking mechanism 100 according to the first embodiment of the present application, in which the structure of the first elastic member 150 and its connection relationship with the operating member 110 and the first cover body 120 can be clearly seen. Specifically, the first elastic member 150 includes a first end 152 and a second end 154 opposite to each other. The first end 152 is connected to a first fixed portion 122 disposed on the first cover body 120, and the second end 154 is connected to a second fixed portion 112 disposed on the operating member 110. As such, the first elastic member 150 is connected between the first cover body 120 and the operating member 110. According to this embodiment, the first end 152 may be in the form of a hook, and likewise, the second end 154 may also be in the form of a hook, but not limited thereto.

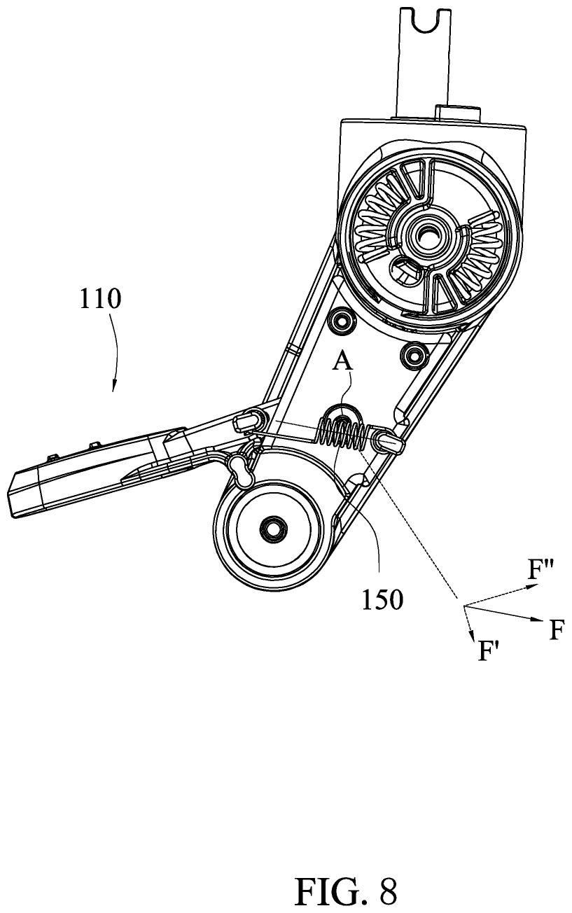

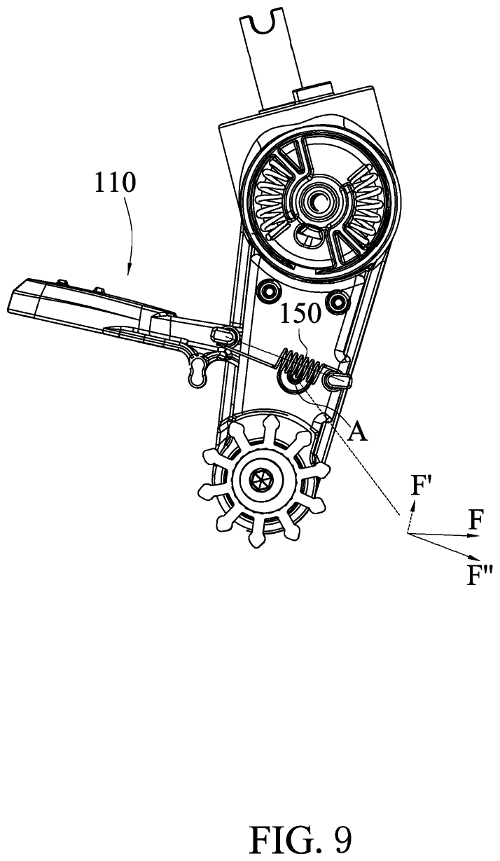

As shown in FIGS. 4 and 5, when a brake is needed, the supervisor can operate the operating member 110 (e.g. depress the pedal), the operating member 110 then pivots downward about the pivoting shaft 132, and the first engaging end 116 of the operating member 110 is engaged in the first engaging groove 160, so as to complete the braking operation; and when a unlock is needed, the supervisor may lift the operating member 110, and the operating member 110 then pivots upward about the pivoting shaft 132, so that the first engaging end 116 of the operating member 110 is unlocked from the first locking groove 160, so as to complete the unlocking operation. Referring to FIGS. 8 and 9, FIGS. 8 and 9 show different corresponding positions of the first elastic member 150 when the operating member according to the first embodiment of the present application is in the locked state and the unlocked state, respectively. The first elastic member 150 provides a pressing force in a locking direction when the operating member 110 of the first locking mechanism 100 performs a locking operation, and the first elastic member 150 provides a releasing force in an unlocking direction when the operating member 110 of the first locking mechanism 100 performs an unlocking operation, so that both the locking operation and the unlocking operation can be reliably performed. The pressing force is applied to the operating member in a direction different from a direction in which the releasing force is applied to the operating member. Specifically, as shown in FIG. 8, when the operating member 110 is depressed, that is, when the operating member 110 is in the locked state, the first elastic member 150 is located below the pivoting point A of the operating member 110 to easily apply a force to the operating member 110. FIG. 8 also shows an exploded view of the elastic force F of the first elastic member 150 at this time, the elastic force F of the first elastic member is divided into a first component force F′ perpendicular to the operating member 110 and a second component force F″ along the operating member 110, so that the elastic force F of the first elastic member 150 can ensure that the operating member 110 is depressed; however, the distance between the first elastic member 150 and the pivoting point A should not be too large, otherwise, the downward rotation angle of the operating member 110 would be increased, which would lead to insufficient depress stroke of the operating member 110, and thusly it is inconvenient for the supervisor to perform the operation. As shown in FIG. 9, when the operating member 110 is lifted, that is, when the operating member 110 is in the unlocked state, the first elastic member 150 is located above the pivoting point A of the operating member 110 to ensure the force applied to the operating member 110. At this time, the elastic force F of the first elastic member 150 can be divided into a first component force F′ perpendicular to the operating member 110 and a second component force F″ along the operating member 110. Thusly, the elastic force F of the first elastic member 150 can ensure the operating member 110 to be lifted. However, the distance between the first elastic member 150 and the pivoting point A of the operating member 110 should not be too large, otherwise the upward rotation angle of the operating member 110 is increased, which may also lead to insufficient lifting stroke of the operating member 110, and thusly, it is not easy for the supervisor to carry out the operation.

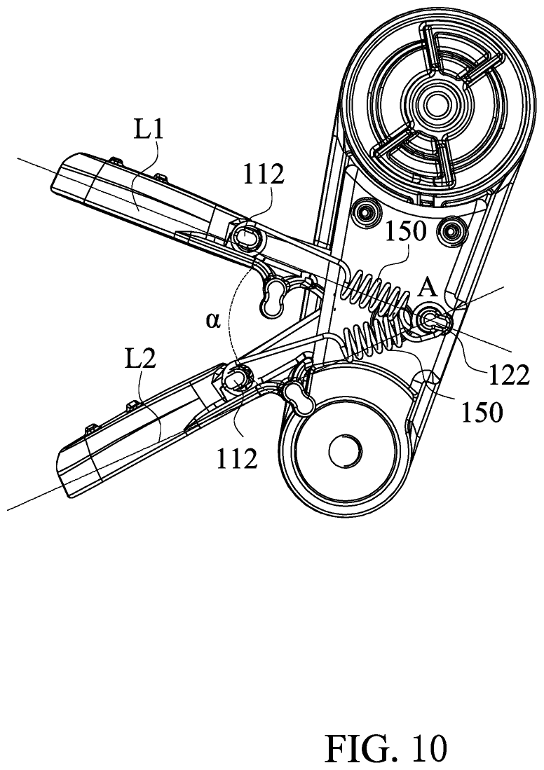

Referring to FIG. 10 again, the angle of the first elastic member is shown in FIG. 10 when the operating member according to the first embodiment of the present application is in the locked state and the unlocked state, respectively. Assuming that the connecting line connecting the second fixed portion 112 of the operating member 110 and the first fixed portion 122 of the first cover body 120 is L1 in the unlocked state, and assuming that the connecting line connecting the second fixed portion 112 of the operating member 110 and the first fixed portion 122 of the first cover body 120 is L2 in the locked state, the angle α between the two connecting lines L1 and L2 is in the range of 35°-50°, preferably 41°, so as to facilitate the locking and unlocking operations, and simultaneously obtain sufficient locking force and unlocking force.

Referring to FIG. 6 again, according to the embodiment shown in the drawing, a stop portion 121 is further disposed on the first cover body 120, and the stop portion may be, for example, but not limited to, in the form of a blocking wall, so as to block the operating member 110 from further pivoting upwards in the unlocked state, and prevent the operating member 110 from rotating upwards after being forced.

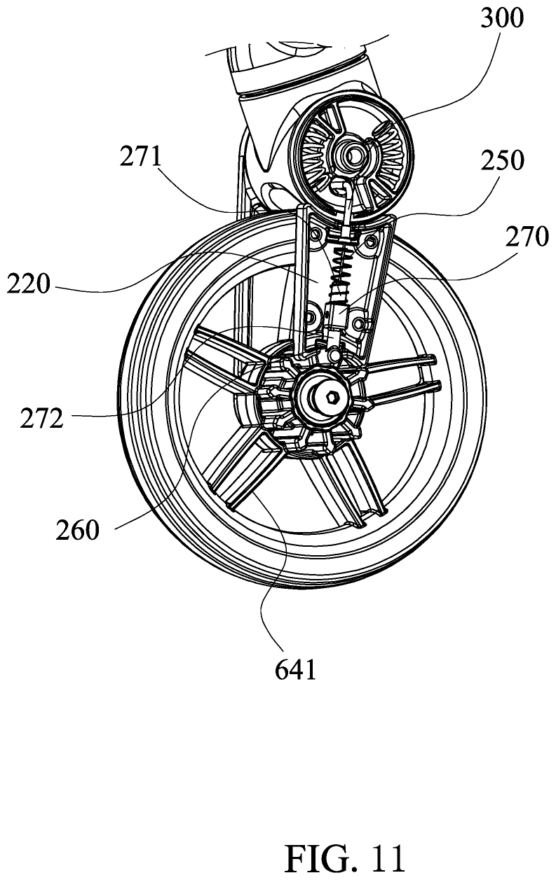

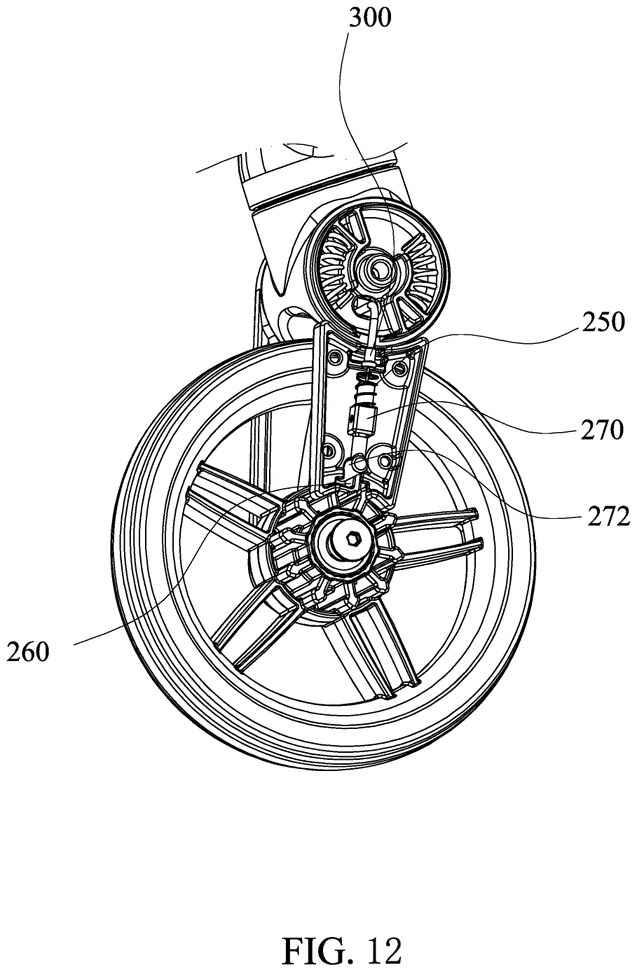

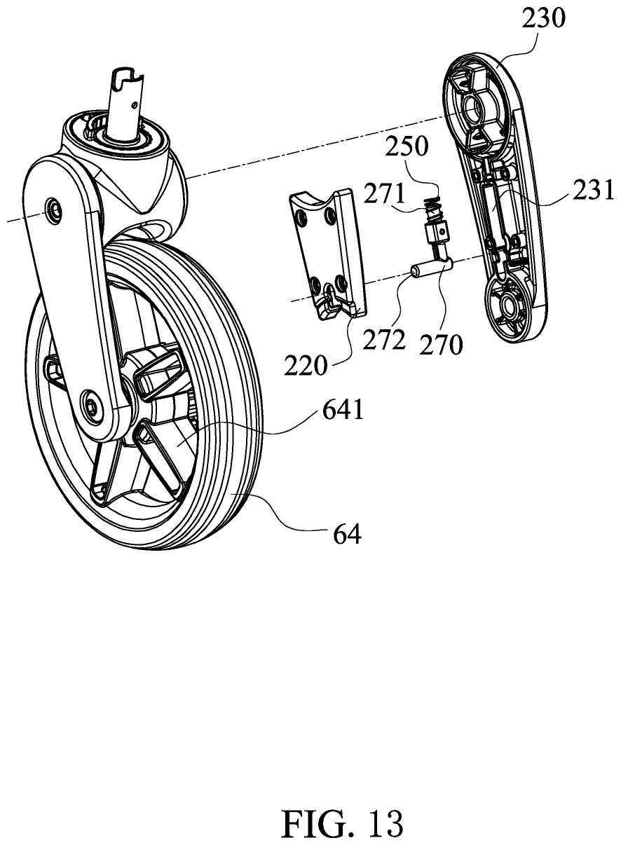

A specific structure of the second locking mechanism 200 according to the first embodiment of the present application will be described below with reference to FIGS. 11, 12, and 13, in which FIG. 11 is a schematic view showing the second locking mechanism according to the first embodiment of the present application, the second locking mechanism in FIG. 11 is in a locked state; FIG. 12 is a schematic view showing the second locking mechanism according to the first embodiment of the present application, the second locking mechanism in FIG. 12 is in a unlocked state; and FIG. 13 is an exploded schematic view showing the second locking mechanism according to the first embodiment of the present application. The second locking mechanism 200 according to the present application includes a second support frame, which in turn includes a third cover body 220, a fourth cover body 230, an engaging member 270, and a second elastic member 250, the engaging member 270 may be in the form of a pin, but not limited thereto. The engaging member 270 is accommodated in an accommodating space formed by the third cover body 220 and the fourth cover body 230 which are snap-fitted with each other. The second elastic member 250 is connected to one end of the engaging member 270. Specifically, in the illustrated embodiment, the fourth cover body 230 is provided with a limiting groove 231. The engaging member 270 is movably disposed in the limiting groove 231. In the illustrated embodiment, the engaging member 270 includes a second snapping end 271 disposed at one end thereof and a second engaging end 272 disposed at the other end thereof. The above second elastic member 250 is connected to the second snapping end 271, meanwhile, the other end of the towing member 300 (i.e. the one end of the towing member 300 connected with the second locking mechanism 200) is also connected to the second snapping end; the second engaging end 272 of the engaging member 270 can be engaged in the second engaging groove 260 disposed on the hub frame 641 of the left wheel 64 or disengaged from the second engaging groove 260 to be unlocked.

As mentioned above, the first locking mechanism 100 and the second locking mechanism 200 according to the present application are linked through the towing member 300. Referring to FIGS. 3 and 11, when the operating member 110 is depressed, one end of the towing member 300 connected with the first locking mechanism 100 moves upward around the pivoting end 113 of the operating member 110 as the operating member 110 pivots downward, so that the towing member 300 is released, meanwhile, the elasticity of the second elastic member 250 of the second locking mechanism 200 may cause the other end of the towing member 300 connected with the second locking mechanism to be pulled down, so that the engaging member 270 is pulled down as well, and the second engaging end 272 of the engaging member 270 is engaged in the second engaging groove 260, thereby the left wheel 64 and the right wheel 62 are locked at the same time. Referring to FIGS. 4 and 12 again, when the operating member 110 is lifted upwards, the operating member 110 pivots upwards about the pivoting shaft 132, and one end of the towing member 300 connected with the first locking mechanism 100 may correspondingly pivot downwards about the pivoting portion 113 of the operating member 110, so that the towing member 300 is pulled tight, and accordingly, the other end of the towing member connected with the second locking mechanism 200 is pulled to move upwards, so as to drive the engaging member 270 to move upwards, and the second engaging end 272 of the engaging member 270 is unlocked from the second engaging groove 260. That is, the unlocking of the left and right wheels 64 and 62 is achieved simultaneously.

It can be seen that, the braking mechanism 10 according to the present application adopts the elastic fitting between the operating member 110 and the towing member 300 and the linkage effect of the towing member to simultaneously brake and unlock the left wheel and the right wheel. It has simple structure, high stability, reduced wear probability of parts and longer durability. Further, fake braking prevention function may be smoother, and there is less false braking problem.

### Second Embodiment

A braking mechanism 10′ according to the second embodiment of the present application will be described below, and in order to avoid redundancy, its differences from the first embodiment will be mainly described in the following description, and descriptions of the same parts will not be repeated.

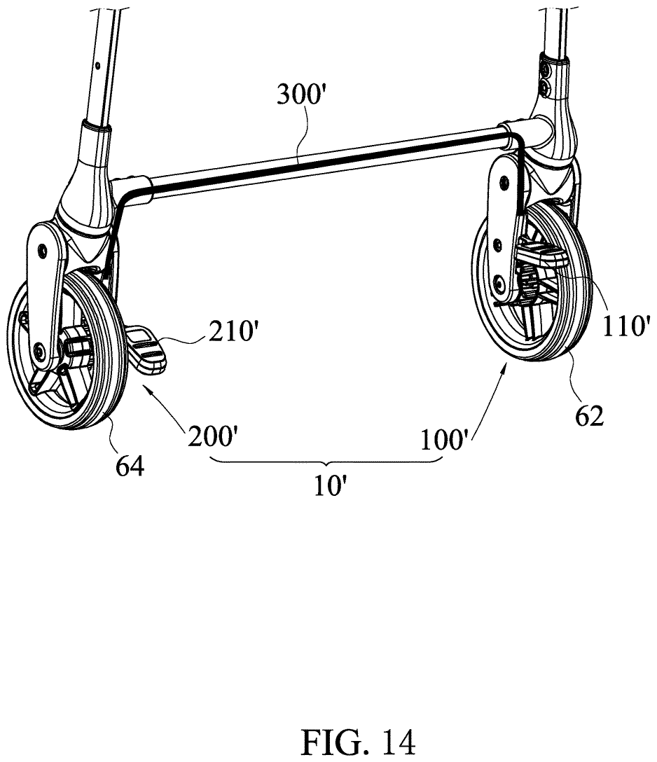

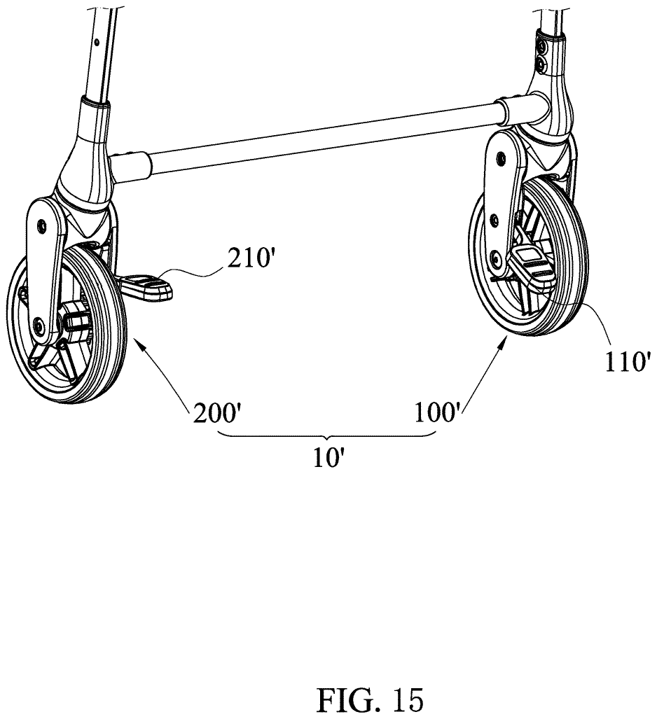

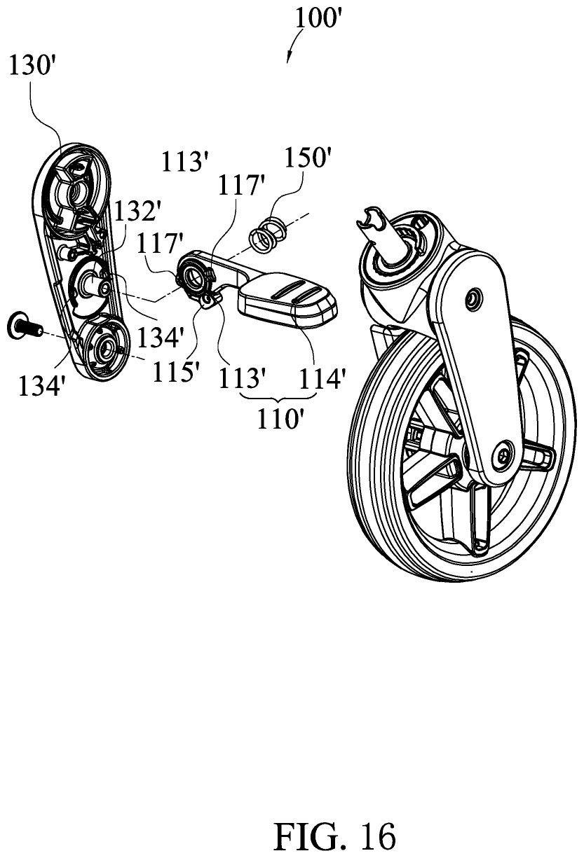

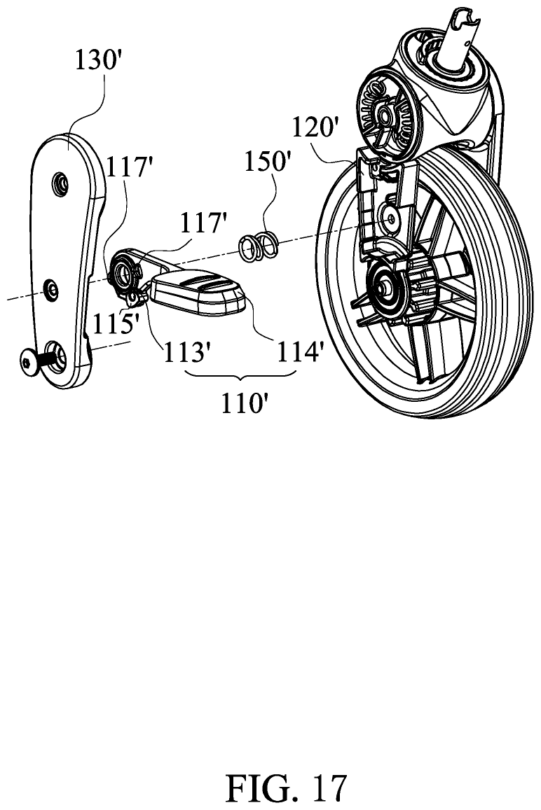

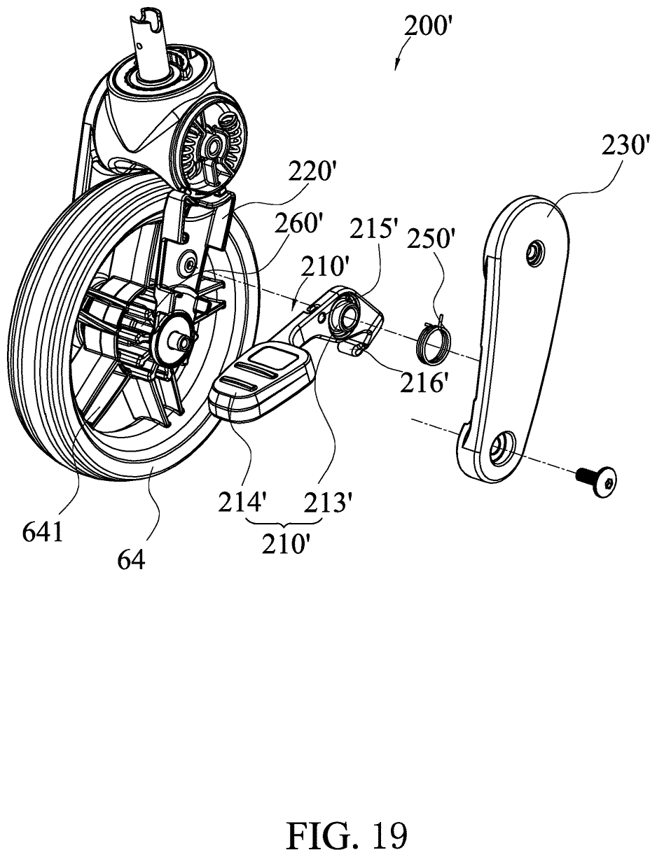

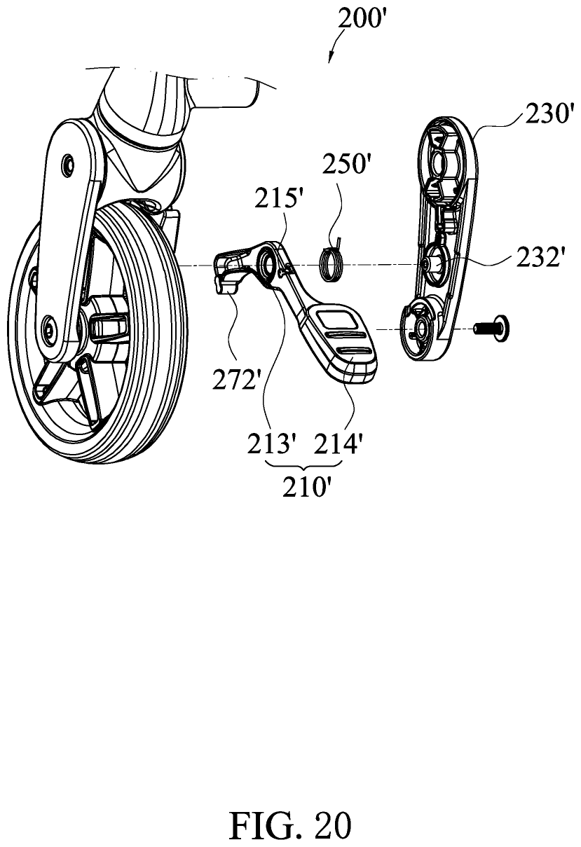

Referring first to FIGS. 14 and 15, in which FIG. 14 is a schematic view showing the braking mechanism according to the second embodiment of the present application, in which both left and right wheels are in an unlocked state; FIG. 15 is a schematic view showing the braking mechanism according to the second embodiment of the present application, in which both the left and right wheels are in a locked state. The braking mechanism 10′ according to this embodiment includes a first locking mechanism 100′, a second locking mechanism 200′, and a towing member 300′, unlike the first embodiment, the first locking mechanism 100′ mainly includes a braking operating member 110′ and a first elastic member 150′ (the first elastic member 150′ is shown in FIGS. 16 and 17) for simultaneously locking the right wheel 62 and the left wheel 64. The second locking mechanism 200′ mainly includes a unlocking operating member 210′ and a second elastic member 250′ (the second elastic member 250′ is shown in FIGS. 19 and 20) for simultaneously unlocking the right wheel 62 and the left wheel 64, and the first locking mechanism 100′ and the second locking mechanism 200′ are linked through the towing member 300′ to achieve simultaneous locking and simultaneous unlocking. The braking operating member 110′ and the unlocking operating member 210′ may be in the form of a pedal in this embodiment, but are not limited thereto. When the supervisor depresses the braking operating member 110′ on the right wheel 62, the left wheel 64 and the right wheel 62 are simultaneously locked, as shown in FIG. 15; and when the supervisor depresses the unlocking operating member 210′ on the left wheel 64, the left wheel 64 and the right wheel 62 are simultaneously unlocked, as shown in FIG. 14. In practice, the braking operating member 110′ and the unlocking operating member 210′ can be clearly distinguished by painting the braking operating member 110′ and the unlocking operating member 210′ with different colors or by providing them with different shapes. The braking operating member 110′ and the unlocking operating member 210′ according to this embodiment may be in the form of a braking pedal and an unlocking pedal, but are not limited thereto.

A structure of the first locking mechanism 100′ according to the second embodiment is described below with reference to FIGS. 16 and 17, in which FIG. 16 is a schematic view showing the first locking mechanism according to the second embodiment of the present application; FIG. 17 is another schematic view showing the first locking mechanism according to the second embodiment of the present application. The first locking mechanism 100′ according to this embodiment further includes a first support frame, which in turn includes, for example, a first cover body 120′ and a second cover body 130′, and the first cover body 120′ and the second cover body 130′ are snap-fitted with each other to form an accommodating space for accommodating the brake operating member 110′. The second cover body 130′ is also provided with a first pivoting shaft 132′. The braking operating member 110′ according to this embodiment further includes a first pivoting portion 113′ and a first actuating portion 114′ disposed at two ends of the braking operating member 110′, respectively, and the first pivoting portion 113′ is pivoted to the first pivoting shaft 132′ of the second cover body 130′, such that the braking operating member 110′ can rotate about the first pivoting shaft 132′. The above first elastic member 150′ is disposed between the first pivoting portion 113′ of the brake operating member 110′ and the first cover body 120′. The braking operating member 110′ further includes a first snapping end 115′ disposed on the first pivoting portion 113′, and one end of the towing member 300′ connected with the first locking mechanism 100′ is connected to the first snapping end 115′.

According to the exemplary structure shown in FIGS. 16 and 17, the braking operating member 110′ further includes a first protrusion 117′ disposed on the first pivoting portion 113′, and correspondingly, the second cover body 130′ further includes a second protrusion 134′ disposed about its pivoting shaft 132′. Preferably, according to the embodiment shown in the drawings, the first protrusion 117′ includes two protrusions disposed radially opposite around the first pivoting portion 113′, and the second protrusion 134′ includes two protrusions disposed radially opposite around the first pivoting shaft 132′. The locked and unlocked states of the braking operating member 110′ can be maintained by the cooperation of the first and second protrusions 117′ and 134′. Specifically, for example, when the braking mechanism 10′ is in the locked state, the first projection 117′ engages with the second projection 134′ to maintain the locked position; and when the braking mechanism 10′ is in the unlocked state, the first protrusion 117′ is engaged with the second protrusion 134′ to maintain the unlocked position. The first protrusion 117′ and the second protrusion 134′ are engaged at different positions to maintain the locked position or the unlocked position.

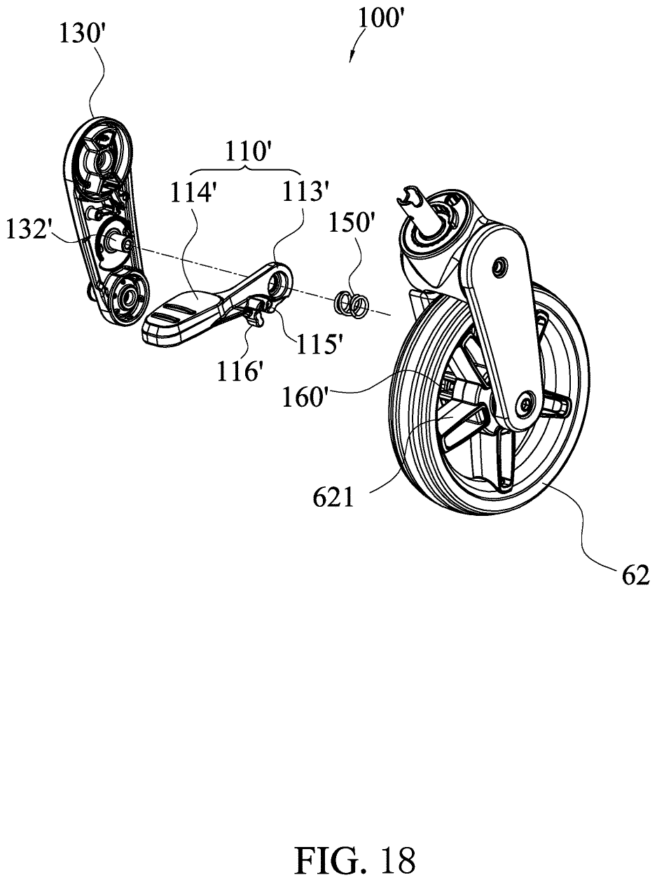

The structure of the first locking mechanism 100′ according to another view of the second embodiment is described below with reference to FIG. 18, which FIG. 18 is a schematic view showing the structure of another view of the first locking mechanism according to the second embodiment of the present application. According to the embodiment shown in the drawing, the first locking mechanism 100′ further includes a first engaging groove 160′ disposed on the hub frame 621 of the right wheel 62, and correspondingly, the braking operating member 110′ further includes a first engaging end 116′ disposed on the first pivoting portion 113′ thereof. In the locked state of the braking mechanism 10′, the first engaging end 116′ can be engaged in the first engaging groove 160′ to realize the braking operation, and in the unlocked state of the braking mechanism 10′, the first engaging end 116′ can be disengaged from the first engaging groove 160′ to realize the unlocking operation.

The structure of the second locking mechanism 200′ according to this second embodiment is shown in FIGS. 19 and 20, in which FIG. 19 is a schematic view showing the second locking mechanism according to the second embodiment of the present application; and FIG. 20 is another schematic view showing the second locking mechanism according to the second embodiment of the present application. The second locking mechanism 200′ according to the second embodiment includes a second support frame, which in turn includes a third cover body 220′ and a fourth cover body 230′, the third cover body 220′ and the fourth cover body 230′ are snap-fitted with each other to form an accommodating space for accommodating the unlocking operating member 210′ of the second locking mechanism 200′. As shown in FIG. 20, the fourth cover body 230′ is provided with a second pivoting shaft 232′, and accordingly, the unlocking operating member 210′ of the second locking mechanism 200′ includes a second pivoting portion 213′ and a second actuating portion 214′, and the second pivoting portion 213′ is correspondingly pivoted to the second pivoting shaft 232′ so that the unlocking operating member 210′ can rotate about the second pivoting shaft 232′. The second elastic member 250′ is disposed between the second pivoting portion 213′ and the fourth cover body 230′.

The unlocking operating member 210′ according to this embodiment further includes a second snapping end 215′ disposed on the second pivoting portion 213′, and one end of the towing member 300′ connected with the second locking mechanism 200′ is connected to the second snapping end 215′. The second locking mechanism 200′ further includes a second engaging groove 260′ disposed on the hub frame 641 of the left wheel 64, and correspondingly, the unlocking operating member 210′ further includes a second engaging end 216′ disposed on the second pivoting portion 213′. When the second locking mechanism 200′ is in the locked state, the second engaging end 216′ is lockable in the second engaging groove 260′, and when the second locking mechanism 200′ is in the unlocked state, the second engaging end 216′ can be unlocked from the second engaging groove 260′.

Referring to FIGS. 14, 18 and 19, the braking operating member 110′ can lock the left wheel 64 and the right wheel 62 at the same time, and the unlocking operating member 210′ can unlock the left wheel 64 and the right wheel 62 at the same time. Specifically, when the braking operating member 110′ of the first locking mechanism 100′ is depressed, since the braking operating member 110′ is depressed to pivot downward, the first engaging end 116′ of the braking operating member 110′ also pivots downward to be engaged in the first engaging groove 160′, the right wheel 62 is locked. During the downward pivoting of the braking operating member 110′ by the depression, the braking operating member 110′ can compress the first elastic member 150′ to twist by the first protrusion 117′ movably abutting against the second protrusion 134′, that is, as the braking operating member 110′ pivots, the first protrusion 117′ continuously abuts against and moves relative to the second protrusion 134′. When the top of the first protrusion 117′ abuts against (in a direction in which the pivoting axis X of the braking operating member 110′ is away from the right wheel 62, corresponding to the highest portion of the first protrusion 117′) the top of the second protrusion 134′ (in a direction in which the pivoting axis X of the braking operating member 110′ is toward the right wheel 62, corresponding to the highest portion of the second protrusion 134′), the first elastic member 150′ assumes a compressed state. Next, as the braking operating member 110′ continuously pivots, the top of the first protrusion 117′ disengages from the top of the second protrusion 134′, the first elastic member 150′ returns from the compressed state, and the engagement between the first protrusion 117′ of the braking operating member 110′ and the second protrusion 134′ of the second cover body 130′ locks the locked state of the rear wheel 62 (the first protrusion 117′ is shown in FIG. 16, and the pivoting axis X is shown in FIG. 18); at the same time, as the braking operating member 110′ pivots downwards, one end of the towing member 300′ connected with the first locking mechanism 100′ is also moved downwards, and correspondingly, one end of the towing member 300′ connected with the second locking mechanism 200′ is moved upwards, so that the second engaging end 216′ of the unlocking operating member 210′ of the second locking mechanism 200′ is correspondingly pivoted downwards to be engaged in the second engaging groove 260′, and the left wheel 64 is locked. At this time, the second elastic member 250′ is also compressed and twisted (the spring compression force of the first elastic member 150′ is greater than the torsion force of the second elastic member 250′ when the top of the first protrusion 117′ is abutted against the top of the second protrusion 134′). Thus, simultaneous locking of the left and right wheels 64, 62 can be achieved by depressing the locking operating member 110′.

When the unlocking operating member 210′ of the second locking mechanism 200′ is depressed, the second actuating portion 214′ of the unlocking operating member 210′ pivots downward. At the same time, one end of the towing member 300′ connected with the unlocking operating member 210′ is also pulled downward along with the depression of the unlocking operating member 210′, and one end of the towing member 300′ connected with the first locking mechanism 100′ moves upward. At this time, for the rear wheel 62, the first engaging end 116′ of the brake operation member 110′ of the first locking mechanism 100′ disengages from the first engaging groove 160′ with the upward movement of the towing member 300′, and for the left wheel 64, the second locking end 216′ of the unlocking operating member 210′ of the second locking mechanism 200′ pivots upward and disengages from the second engaging groove 260′ with the downward movement of the towing member 300′. And at this time, during the pivot of the braking operating member 110′ being rotated upward by the towing member 300′, the braking operating member 110′ is twisted by the first protrusion 117′ being in movable abutment with the second protrusion 134′ and compressing the first elastic member 150′, that is, as the braking operating member 110′ pivots, the first protrusion 117′ is in continuous abutment with the second protrusion 134′ and moves relatively. When the top of the first protrusion 117′ (corresponding to the highest portion of the first protrusion 117′ in the direction of the pivoting axis X of the braking operating member 110′ away from the right wheel 62) is abutted against the top of the second protrusion 134′ (corresponding to the highest portion of the second protrusion 134′ in the direction of the pivoting axis X of the braking operating member 110′ toward the right wheel 62) again, the first elastic member 150′ assumes a compressed state. Next, as the braking operating member 110′ is continuously pivoted, the top of the first protrusion 117′ is out of abutment with the top of the second protrusion 134′, the first elastic member 150′ is released from the compressed state and returns. At this time, the engagement manner of the first protrusion 117′ of the braking operating member 110′ and the second protrusion 134′ of the second cover body 130′ is changed to maintain the unlocked state, thereby achieving the unlocking of the right wheel 62; likewise, as the unlocking operating member 210′ pivots downward, the second engaging end 216′ of the unlocking operating member 210′ pivots upward, and the second elastic member 250′ releases the compressive torsion force, so as to further maintain the state that the second engaging end 216′ is released from the second engaging groove 260′, thereby achieving the unlocking of the left wheel 64. Therefore, simultaneous unlocking of the left and right wheels 64 and 62 can be achieved by operation of the unlocking operation member 210′. The first elastic member 150′ has a greater elastic force than the second elastic member 250′ to ensure that the second locking mechanism 200′ can be pulled and to ensure that only a small force is required to pivot the unlocking operating member 210′ and the braking operating member 110′ to unlock the left wheel 64 and the rear wheel 62.

The braking mechanism 10′ according to this embodiment can also realize simultaneous braking and unlocking of the left wheel and the right wheel. It has simple structure, high stability, reduced wear probability of parts and longer durability. Further, fake braking prevention function may be smoother, and there is less false braking problem.

In the first and second embodiments mentioned above, the towing members 300 and 300′ are both integral structures, such as a complete pull rope connected between the left wheel 64 and the right wheel 62, to achieve the linkage between the first locking mechanisms 100 and 100′ and the second locking mechanisms 200 and 200′, but not limited to this. For example, the towing members 300 and 300′ can also be in a separate form.

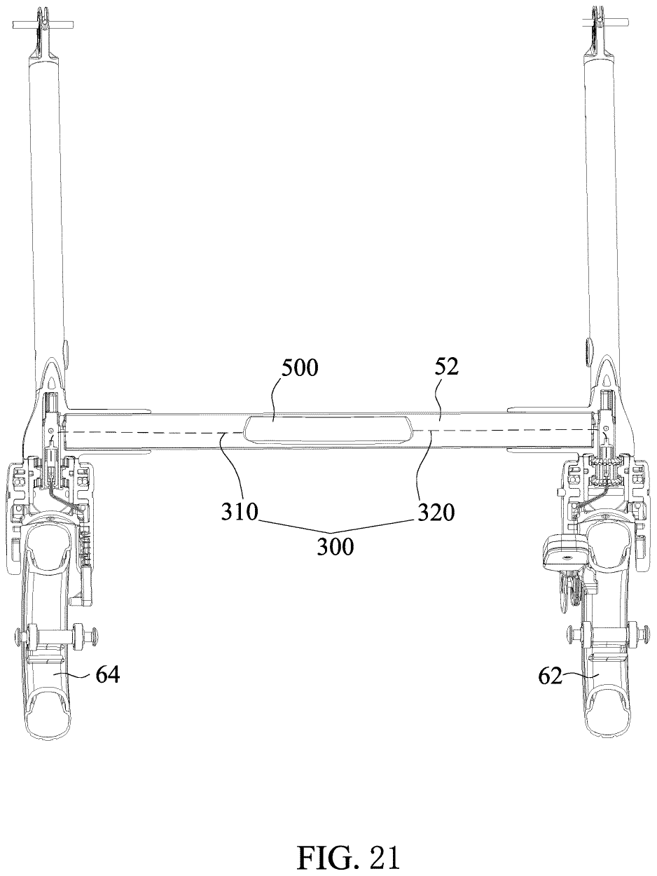

The structure of another embodiment of the towing member according to the present application will be explained in the following by reference to FIGS. 21 to 23. The towing member of the another embodiment can be applied to the towing member 300 of the first embodiment as well as the towing member 300′ of the second embodiment. For convenience of explanation, the towing member 300 of the first embodiment will be detailed explained as an example. FIG. 21 is a schematic view showing an another embodiment of the towing member, in which the cover body 500 is covered on the connecting crossbar 52;

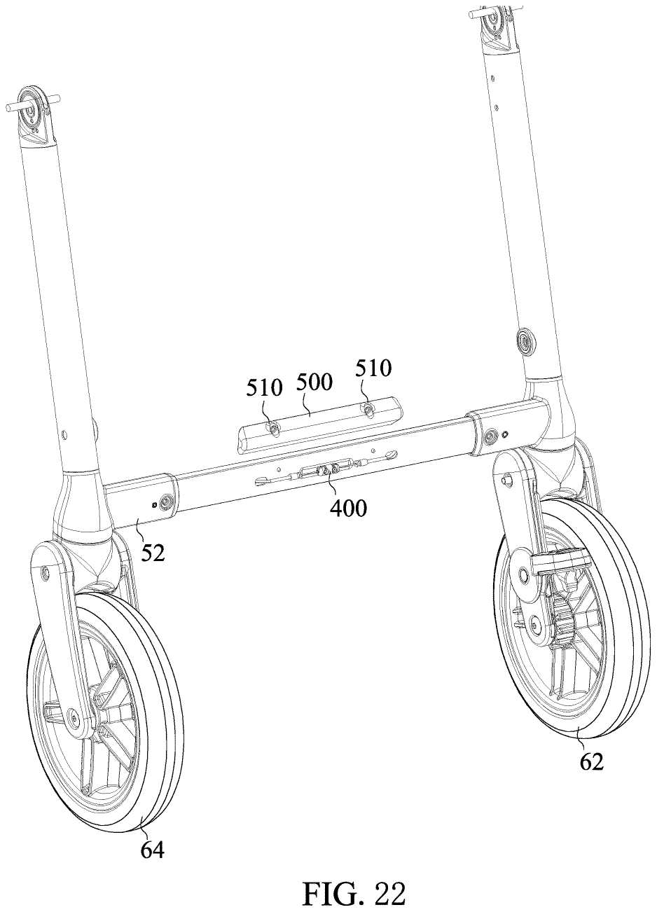

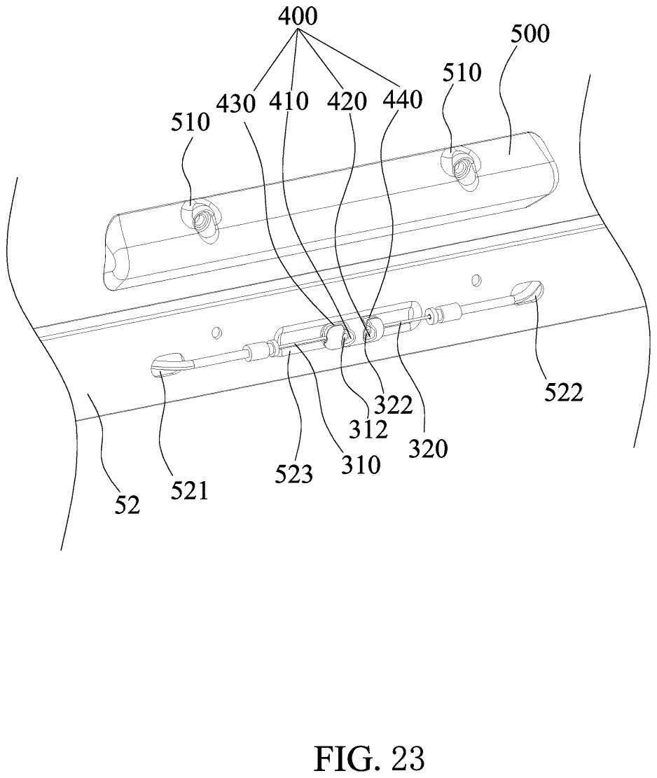

FIG. 21 is a schematic diagram illustrating another embodiment of the traction component according to the present application, wherein the cover body 500 is engaged on the connecting crossbar 52; FIG. 22 is a schematic view showing an another embodiment of the towing member, in which the cover body 500 is removed from the connecting crossbar 52 to clearly show the inner structure; FIG. 23 is a partial schematic diagram showing the connecting portion of the towing member.

The towing member 300 according to this embodiment has a separated structure and includes a first towing portion 310 and a second towing portion 320 which are connected to each other through a connecting member 400, and the connecting member 400 is provided at a connecting crossbar 52 connecting the left wheel 64 and the right wheel 62, for example, the connecting member 400 is provided in a receiving portion 523 which is provided at the connecting crossbar 52, and covered by a cover body 500. The cover body 500 can be connected to the connecting crossbar 52 via connecting holes by screws as an example. There are two connecting holes shown in FIG. 22, but the number of the connecting hole can be set based on the requirement.

The detailed structure of the connecting member 400 is shown in FIG. 23. The connecting member 400 includes a first opening 410 and a second opening 420, and the first opening 410 has a dimension larger than a first end part 312 of the first towing portion 310, the second opening 420 has a dimension larger than a second end part 322 of the second towing portion 320, for receiving the first end part 312 of the first towing portion 310 and the second end part 322 of the second towing portion 320, respectively. The connecting member 400 further includes a first fitting slot 430 and a second fitting slot 440, and the first fitting slot 430 has a dimension smaller than that of the first opening 410, the second fitting slot 440 has a dimension smaller than that of the second opening 420. The first fitting slot 430 is communicated with the first opening 410, and the second fitting slot 440 is communicated with the second opening 420, to prevent the first end portion 312 received in the first opening 410 and the second end portion 322 received in the second opening 420 from falling out, respectively. The first fitting slot 430 and the second fitting slot 440 shown in FIG. 23 are both L-shaped slots, but they are not limited to this shape.

The towing member 300 according to this embodiment includes a first towing portion 310 and a second towing portion 320. The first end part 312 of the first towing portion 310 can be received and clamped in the first opening 410 of the connection member 400 after being penetrated from the first perforation 521 provided at the connecting crossbar 52; and the second end part 322 of the second towing portion 320 can be received and clamped in the second opening 420 of the connecting member 400 after being penetrated from the second perforation 522 provided at the connecting crossbar 52. Thusly, the first towing portion 310 and the second towing portion 320 of the towing member 300 are connected to each other through the connecting member 400 to achieve the linkage between the first locking mechanisms 100, 100′ and the second locking mechanisms 200, 200′, and at the same time, the towing member in a separated form is more convenient for assembly.

Since the characteristics of the disclosure can be embodied in various forms without departing from the characteristics of the disclosure, it should also be understood, the above embodiments are not limited to any details described above, unless otherwise noted, rather, it should be interpreted broadly as being within the scope defined by the appended claims. Therefore, all modifications and variations falling within the scope and limits of the claims or equivalent solutions of such scope and limits shall be covered by the appended claims.

1-36. (canceled)

37. A braking mechanism comprising:
a first locking mechanism for locking a first wheel;
wherein the first locking mechanism comprises an operating member and a first elastic member, and locking and unlocking of the first wheel is realized by cooperation between the operating member and the first elastic member,
the first elastic member provides a pressing force in a locking direction when the operating member of the first locking mechanism performs a locking operation, and provides a releasing force in an unlocking direction when the operating member of the first locking mechanism performs an unlocking operation.

38. The braking mechanism according to claim 37, wherein the operating member comprises a pivoting portion and an actuating portion which are respectively at two ends of the operating member; the first locking mechanism comprises a first support frame, the first support frame is provided with a pivoting shaft, and the pivoting portion of the operating member is connected to the pivoting shaft, so that the operating member is rotatable about the pivoting shaft.

39. The braking mechanism according to claim 37, wherein the pressing force is applied to the operating member in a direction different from a direction in which the releasing force is applied to the operating member.

40. The braking mechanism according to claim 37, wherein in the locked state, the first elastic member is located below the pivoting point of the operating member, and in the unlocked state, the first elastic member is located above the pivoting point of the operating member.

41. The braking mechanism according to claim 37, wherein in the locked state, the elastic force of the first elastic member has a first component force perpendicular to the operating member and a second component force along the operating member to ensure that the operating member is depressed.

42. The braking mechanism according to claim 37, wherein in the unlocked state, the elastic force of the first elastic member has a first component force perpendicular to the operating member and a second component force along the operating member to ensure that the operating member is lifted.

43. The braking mechanism according to claim 37, further comprising a second locking mechanism for locking a second wheel, wherein the second locking mechanism comprises:
a second support frame;
an engaging member accommodated in the second support frame; and
a second elastic member connected to the engaging member, and the elastic force of the second elastic member causes the second locking mechanism to be in the locked state.

44. The braking mechanism according to claim 43, further comprising towing member, and both locking and unlocking of the first locking mechanism and the second locking mechanism are linked through the towing member.

45. A braking mechanism comprising:
a first locking mechanism comprising a braking operating member and a first elastic member for simultaneously locking a first wheel and a second wheel;
a second locking mechanism comprising an unlocking operating member and a second elastic member for simultaneously unlocking the first wheel and the second wheel, the first elastic member having an elastic force larger than that of the second elastic member; and
a towing member, the first locking mechanism and the second locking mechanism are linked through the towing member.

46. The braking mechanism according to claim 45, wherein the first locking mechanism comprises a first support frame, and the first support frame comprises a first cover body and a second cover body, and the first cover body and the second cover body are snap-fitted with each other to form an accommodating space for accommodating the braking operating member.

47. The braking mechanism according to claim 46, wherein the second cover body is provided with a first pivoting shaft, and the braking operating member comprises a first pivoting portion and a first actuating portion, the first pivoting portion is pivoted on the first pivoting shaft, and the first elastic member is disposed between the first pivoting portion and the first cover body.

48. The braking mechanism according to claim 47, wherein the braking operating member further comprises a first snapping end disposed on the first pivoting portion, and one end of the towing member connected with the first locking mechanism is connected to the first snapping end.

49. The braking mechanism according to claim 47, wherein the first locking mechanism further comprises a first engaging groove which is disposed on a hub frame of the first wheel; the braking operating member further comprises a first engaging end disposed on the first pivoting portion, and the first engaging end is lockable to the first engaging groove or unlockable from the first engaging groove.

50. The braking mechanism according to claim 47, wherein the braking operating member further comprises a first protrusion disposed on the first pivoting portion, and the second cover body further comprises a second protrusion, and the locked and unlocked states of the braking operating member are maintained through different fitting ways of the first protrusion and the second protrusion, respectively.

51. The braking mechanism according to claim 45, wherein the second locking mechanism comprises a second support frame, and the second support frame comprises a third cover body and a fourth cover body, and the third cover body and the fourth cover body are snap-fitted with each other to form an accommodating space for accommodating the unlocking operating member.

52. The braking mechanism according to claim 51, wherein the fourth cover body is provided with a second pivoting shaft, and the unlocking operating member comprises a second pivoting portion and a second actuating portion, the second pivoting portion is pivoted on the second pivoting shaft, and the second elastic member is disposed between the second pivoting portion and the fourth cover body.

53. The braking mechanism according to claim 52, wherein the unlocking operating member further comprises a second snapping end disposed on the second pivoting portion, and the one end of the towing member connected with the second locking mechanism is connected to the second snapping end.

54. The braking mechanism according to claim 52, wherein the second locking mechanism further comprises a second engaging groove which is disposed on a hub frame of the second wheel; the unlocking operating member further comprises a second engaging end disposed on the second pivoting portion, and the second engaging end is lockable to the second engaging groove or unlockable from the second engaging groove.

55. The braking mechanism according to claim 44, wherein the towing member has a separated structure and comprises a first towing portion and a second towing portion which are connected to each other through a connecting member.

56. A child stroller comprising:
a wheel assembly comprising a left wheel and a right wheel;
a frame which is supported on the wheel assembly; and
a braking mechanism as claimed in claim 37.
